(19) United States
(12) Patent Application Publication
(10) Pub. No.: US 2006/0216563 A1
(43) Pub. Date: Sep. 28, 2006

(54) Electrolyte membrane, electrolyte membrane composite, method of manufacturing electrolyte membrane composite, electrolyte membrane-electrode assembly for fuel cell, method of manufacturing electrolyte membrane-electrode assembly for fuel cell, and fuel cell

(76) Inventor: Masafumi Matsunaga, Tokyo (JP)

Correspondence Address: WOOD, HERRON & EVANS, LLP (NORDSON), 2700 CAREW TOWER, 441 VINE STREET, CINCINNATI, OH, 45202, US

(21) Appl. No.: 10/567,135

(22) PCT Filed: Aug. 10, 2004
(86) PCT No.: PCT/JP04/11727

§ 371 Date: Feb. 6, 2006

(51) Int. Cl. H01M 8/10; H01M 2/08; H01M 4/88; B05D 5/12

(52) U.S. Cl. 429/30; 429/35; 427/115; 502/101

(57) ABSTRACT

An electrolyte membrane is for forming an electrode having a desired shape with high quality and highly efficient productivity. Masking members (12 and 13) having holes (12a and 13a) bored in a desired electrode shape are attached to at least one side of an electrolyte membrane (11) for a fuel cell before an electrode is applied to the electrolyte membrane, in a self-adhering fashion or through a slight adhesive.

### TECHNICAL FIELD

The preset invention relates to an electrolyte membrane, an electrolyte membrane composite, a method of manufacturing an electrolyte membrane composite, an electrolyte membrane-electrode assembly (MEA) for a fuel cell, a method of manufacturing an electrolyte membrane-electrode assembly (MEA) for a fuel cell, and a fuel cell. In particular, the invention relates to an electrolyte membrane and electrode for a proton-exchange electrolyte membrane fuel cell (PEFC).

### BACKGROUND ART

Up to now, there have been known as a method of forming an electrode for a proton-exchange membrane fuel cell, a method of directly applying an liquid electrode ink to an electrolyte membrane and drying the ink to thereby form an electrode, a method of applying liquid electrode ink to a fluorine-based film or polyester-based film that has undergone mold-release treatment and drying the ink, and then transferring the ink onto the electrolyte membrane under heat and pressure to thereby form an electrode, and a method of applying liquid electrode ink to one surface of a gas diffusion layer that is generally called “carbon paper” and drying the ink, and then heat-pressing the ink onto the electrolyte membrane or the electrolyte membrane where an electrode is preformed with a desired thickness (see Japanese Patent Application Laid-open No. 9-501535, for example). Meanwhile, in light of oncoming needs for total control of volatile organic compound (VOC), an attempt has been made to use a method of applying to an electrolyte membrane or the like a powder electrode material containing a mixture of carbon carrying particles of platinum etc. as a catalyst and an electrolyte solution in place of the liquid electrode ink.

As a method of manufacturing an electrolyte membrane-electrode assembly for a fuel cell, a method of directly applying liquid electrode ink to an electrolyte membrane is exemplified. This method is regarded as promising in respect of adhesion, performance, and lower cost due to fewer steps, in the case where liquid electrode ink is directly applied to an electrolyte membrane in such a way that prevents any cracks and pinholes from developing in a coating film.

However, broadly speaking, the following two problems arise in the case of directly applying liquid electrode ink to an electrolyte membrane.

Firstly, an electrolyte membrane is damped or swelled as soon as the membrane contacts with a solvent of liquid electrode ink, i.e., water or alcohol solvent, or moisture in the air. If left to stand as it is, the electrolyte membrane immediately deforms beyond recognition.

Secondly, a wet coat thickness of the liquid electrode ink, that is to be applied to the electrolyte membrane, is large. A solid content in the liquid electrode ink is about 5 to 15%. A dry weight of an electrolyte membrane-electrode assembly for a fuel cell is generally in a range of about 0.5 to 6 mg/cm², mostly about 0.8 to 3 mg/cm², although varying depending on a catalyst (e.g., platinum) content. A wet coat thickness of the liquid electrode ink, which is converted from the above values, is about 50 to 600 μm. When a coating having such a large wet coat thickness is applied on a substrate even with the general coating operation, it may require considerable efforts to prevent drooling, cracks, blisters upon blistering phenomenon, and bubbling phenomena involving pinholes as an aggregate of bubbles, e.g., microbubbles.

A measure for solving the above-mentioned problem is to increase a concentration of the electrode ink, that is, to volatize as much solvent as possible from the electrode ink before the electrode ink reaches the electrolyte membrane. To that end, it is important to select a spray coating method where the electrode ink is applied in the form of liquid droplet and even particle as fine as possible, which can contact the air with a larger area instead of using a conventional liquid film coating method, typically, roll coating, die coating with a slot nozzle, curtain coating, or screen printing. Here, the spray coating is a method of applying a liquid in the particle form and hence particles are readily dispersed. It is thus impossible to form an electrode pattern having a desired sharp pattern contour. Therefore, the use of a masking member is indispensable.

For example, methods as disclosed in Japanese Patent Application Laid-open Nos. 4-135670, 4-176363, and 4-210273 are simple automatic masking methods in the general coating field. However, the application of the electrode ink requires removal of the dried electrode ink adhering to the masking member by using a solvent on a production line. There is a danger that the catalyst ignites at the time of heat generation because of its own property or that it inflames at the time of contacting the solvent. A large amount of waste liquid or waste containing electrode ink, which is discarded after the above operations is transported to a catalyst manufacturer etc. for reuse of platinum. Any unnecessary washing solvent is used to involve a cost for a solvent. Besides, a cost is also required for an operator to clean the masking member after the completion of the operation. The solvent is handled as explosives and combustibles or involves the aforementioned problem, and hence requires a cost for transporting means.

Also, in the case of spray-coating electrode ink or/and powder electrode material to the electrolyte membrane, there arises a problem that the masking member floats over the electrolyte membrane to cause the applied electrode ink or/and powder electrode material to infiltrate in a gap between the masking member and the electrolyte membrane. Such a case involves a problem that an electrode with a desired pattern cannot be formed with accuracy.

### DISCLOSURE OF INVENTION

The present invention has been made in view of the above-mentioned problems and therefore has an object to provide an electrolyte membrane, an electrolyte membrane composite, a method of manufacturing an electrolyte membrane composite, an electrolyte membrane-electrode assembly for a fuel cell, a method of manufacturing an electrolyte membrane-electrode assembly for a fuel cell, and a fuel cell, for manufacturing an electrode having a desired pattern with high quality and highly efficient productivity.

In order to attain the above-mentioned object, the present invention provides an electrolyte membrane as described below.

That is, the present invention provides an electrolyte membrane for a fuel cell before an electrode is applied to the electrolyte membrane, a masking member having a hole bored in a shape of a desired electrode being laminated on at least one side of the electrolyte membrane.

With such a structure, no gap is left between the electrolyte membrane and the masking member, whereby an electrode having a desired shape can be formed with accuracy.

Also, it is unnecessary to separately mount a masking member to a coating device. An electrode with a desired shape (pattern) can be manufactured with accuracy only by mounting an electrolyte membrane of the present invention to the coating device.

In addition, according to the present invention, electrode ink adhering to the masking member and dried is taken up together with the masking member. Hence, the taken-up masking member is transported to a catalyst manufacturer for reuse of platinum. Consequently, it is possible to dispense with a washing solvent for cleaning the masking member and to skip the cleaning step.

In the electrolyte membrane for a fuel cell, masking members having similar holes bored in a shape of a desired electrode may be laminated on both sides of the electrolyte membrane.

In the electrolyte membrane for a fuel cell, the masking member may self-adhere to the electrolyte membrane or adhere to the electrolyte membrane through a slight adhesive.

In the electrolyte membrane for a fuel cell, the electrolyte membrane and/or the masking member may be a web, and the electrolyte membrane may be made into a roll stock.

In the electrolyte membrane for a fuel cell, the electrolyte membrane may be cut into sheets.

In the electrolyte membrane for a fuel cell, a gas barrier sheet or web may be laminated on at least one masking member.

In the electrolyte membrane for a fuel cell, a thickness of the masking member may be substantially the same as or larger than a thickness of an electrode to be formed in a post-process.

In the electrolyte membrane for a fuel cell, the electrolyte membrane may be wrapped with a gas barrier wrapping material.

Also, in the electrolyte membrane for a fuel cell, the electrolyte membrane-electrode assembly is manufactured by applying or filling-in an electrode ink or/and a powder electrode material on an electrolyte membrane for a fuel cell through a hole of a masking member of the electrolyte membrane for the fuel cell, and by peeling off the masking member.

The electrolyte membrane for a fuel cell laminated with the masking member is used, whereby the electrolyte membrane-electrode assembly for a fuel cell can be formed with high productivity and accuracy.

In the electrolyte membrane-electrode assembly for a fuel cell, the electrode ink or/and the powder electrode material may be fixed to the electrolyte membrane for the fuel cell.

In particular, in the electrolyte membrane-electrode assembly for a fuel cell, the electrode ink or/and the powder electrode material may be dried or heated or/and pressed so as to be fixed to the electrolyte membrane for the fuel cell.

A fuel cell may be manufactured by using the electrolyte membrane-electrode assembly for a fuel cell.

Also, according to the present invention, an electrolyte membrane composite, includes: an electrolyte membrane; and a masking member provided with a plurality of holes, in which the masking member is detachably attached to one side of the electrolyte membrane.

In the electrolyte membrane composite, the holes may be shaped in a shape of a fuel electrode for a fuel cell.

The electrolyte membrane composite may further include a gas barrier sheet.

The electrolyte membrane composite may further include a masking member detachably attached to the other side of the electrolyte membrane.

In the electrolyte membrane composite, the gas barrier sheet may be detachably attached to the masking member or the electrolyte membrane.

In the electrolyte membrane composite, the masking member and the gas barrier sheet may be made of an autohesion material and detachably attached to the electrolyte membrane without using an adhesive.

In the electrolyte membrane composite, the electrolyte membrane composite may be wound to be made into a roll stock.

In the electrolyte membrane composite, the roll stock of the electrolyte membrane composite may be wrapped with a gas barrier wrapping material.

According to an aspect of the present invention, a method of manufacturing an electrolyte membrane composite having an electrolyte membrane and a masking member, includes: boring a desired shape hole in the masking member; and thereafter, attaching the masking member to the electrolyte membrane.

According to another aspect of the present invention, a method of manufacturing an electrolyte membrane composite having an electrolyte membrane and a masking member, includes: attaching the masking member to the electrolyte membrane; and thereafter, boring a desired shape hole in the masking member.

According to another aspect of the present invention, a method of manufacturing an electrolyte membrane-electrode assembly for a fuel cell, includes: installing rotatably a roll stock of an electrolyte membrane composite having an electrolyte membrane and a masking member provided with a plurality of holes; drawing the electrolyte membrane composite from the roll stock; applying or filling in an electrode ink or/and a powder electrode material on the electrolyte membrane through the plurality of holes of the masking member while transporting the electrolyte membrane composite or preparing a laminate thereof; fixing the applied electrode ink or/and powder electrode material to the electrolyte membrane; and peeling off the masking member from the electrolyte membrane. In particular, in the case of using the powder electrode material, the material may be fixed to the electrolyte membrane by a heating/pressing method.

Also, according to another aspect of the present invention, a method of manufacturing an electrolyte membrane-electrode assembly for a fuel cell, includes: installing rotatably a roll stock of an electrolyte membrane composite having an electrolyte membrane, a masking member provided with a plurality of holes, and a gas barrier sheet; drawing the electrolyte membrane composite from the roll stock; peeling off the gas barrier sheet; applying or filling in an electrode ink or/and a powder electrode material on the electrolyte membrane through the plurality of holes of the masking member while transporting the electrolyte membrane composite or preparing a laminate thereof; fixing the electrode ink or/and the powder electrode material to the electrolyte membrane; and peeling off the masking member from the electrolyte membrane.

Further, according to another aspect of the present invention, a method of manufacturing an electrolyte membrane-electrode assembly for a fuel cell, includes: installing rotatably a roll stock of an electrolyte membrane composite having an electrolyte membrane, a first masking member attached to a first side of the electrolyte membrane and provided with a plurality of holes, and a second masking member attached to a second side of the electrolyte membrane and provided with a plurality of holes; drawing the electrolyte membrane composite from the roll stock; applying or filling in an electrode ink or/and a powder electrode material on the first side of the electrolyte membrane through the plurality of holes of the first masking member while transporting the electrolyte membrane composite or preparing a laminate thereof; fixing the electrode ink or/and the powder electrode material to the electrolyte membrane; peeling off the first masking member from the electrolyte membrane; reversing the electrolyte membrane and the second masking member; applying or filling in the electrode ink or/and the powder electrode material on the second side of the electrolyte membrane through the plurality of holes of the second masking member while transporting the electrolyte membrane and the second masking member or preparing a laminate thereof; fixing the electrode ink or/and the powder electrode material to the electrolyte membrane; and peeling off the second masking member from the electrolyte membrane.

Further, according to another aspect of the present invention, the present invention, a method of manufacturing an electrolyte membrane-electrode assembly for a fuel cell, includes: installing a sheet of an electrolyte membrane composite having an electrolyte membrane and a masking member provided with at least one hole; applying or filling in an electrode ink or/and a powder electrode material on the electrolyte membrane through the at least one hole of the masking member or preparing a laminate thereof; fixing the electrode ink or/and the powder electrode material to the electrolyte membrane; and peeling off the masking member from the electrolyte membrane.

Further, according to another aspect of the present invention, a method of manufacturing an electrolyte membrane-electrode assembly for a fuel cell, includes: filling in or/and applying a powder electrode material through a plurality of holes of first and second masking members laminated on both sides of an electrolyte membrane; optionally increasing a bulk density by one or a combination of roll-pressing, oscillation, and vacuum degassing and optionally reiterating the filling in or/and applying and the increasing the density of the powder electrode material; heating or/and pressing the electrolyte membrane to be fixed when a desired thickness is reached; and peeling off the first and second masking members from the electrolyte membrane.

The method of manufacturing an electrolyte membrane-electrode assembly for a fuel cell may further include cutting the electrolyte membrane.

An electrolyte membrane-electrode assembly for a fuel cell according to the present invention is manufactured by the method of manufacturing an electrolyte membrane-electrode assembly for a fuel cell.

A fuel cell may be manufactured by using the electrolyte membrane-electrode assembly for a fuel cell.

According to the present invention, it is possible to accurately apply the electrode ink or powder electrode material to the electrolyte membrane with a desired pattern and to improve productivity in forming an electrode for a fuel cell, which is particularly useful.

According to the present invention, no gap is allowed between the electrolyte membrane and the masking member, making it possible to manufacture the electrode having the desired shape with accuracy.

Also, it is unnecessary to separately mount the masking member to the coating device. The electrode with the desired shape (pattern) can be manufactured with accuracy only by mounting the electrolyte membrane of the present invention to the coating device.

In addition, according to the present invention, the electrode ink adhering to the masking member and dried is taken up together with the masking member. Hence, the taken-up masking member is transported to a catalyst manufacturer for reuse of platinum. Consequently, it is possible to dispense with a washing solvent for cleaning the masking member and to skip the cleaning step.

### BRIEF DESCRIPTION OF THE DRAWINGS

FIG. 1 is a perspective view of an electrolyte membrane composite 1 according to the present invention;

FIG. 2 is an exploded view of the electrolyte membrane composite 1;

FIG. 3 shows how a wrapping material 20 wraps the rolled electrolyte membrane composite 1;

FIG. 4 shows the electrolyte membrane composite 1 whose one side is attached with a gas barrier sheet 14;

FIG. 5 shows how the electrolyte membrane composite 1 is rolled with the gas barrier sheet 14 facing outwardly;

FIG. 6 is a schematic diagram of a coating device 30 for applying electrode ink to the electrolyte membrane composite 1;

FIG. 7 is a perspective view of an electrolyte membrane composite 101 according to the present invention;

FIG. 8 is an exploded view of the electrolyte membrane composite 101;

FIG. 9 shows the electrolyte membrane composite 101 where a second side 111b of an electrolyte membrane 111 is attached to a gas barrier sheet 114;

FIG. 10 shows the electrolyte membrane composite 101 having a masking member 112 attached to, the gas barrier sheet 114;

FIG. 11 is a schematic diagram of a coating device 130 for applying electrode ink to the electrolyte membrane composite 101;

FIG. 12 is a schematic diagram of the coating device 130 for applying electrode ink to the electrolyte membrane composite 101;

FIG. 13 illustrates a method of manufacturing an electrolyte membrane composite;

FIG. 14 illustrates another method of manufacturing an electrolyte membrane composite;

FIG. 15 is a schematic sectional view of a device for applying to, that is, filling in an electrolyte membrane composite a powder electrode material;

FIG. 16 shows a pressure/vacuum recovery system 550;

FIG. 17 is a plan view of a belt 558;

FIG. 18 is a side view of the belt 558;

FIG. 19 is a schematic sectional view of a filling device for applying to, that is, filling in an electrolyte membrane a powder electrode material;

FIG. 20 is a schematic sectional view of a coating device for applying a powder electrode material to an electrolyte membrane; and

FIG. 21 shows an example of a case of applying an electrode ink EI and a powder electrode material P one on top of the other.

### BEST MODE FOR CARRYING OUT THE INVENTION

Hereinafter, the present invention will be described based on preferred embodiments with reference to the accompanying drawings. Note that in the following description of the embodiments, sizes, materials, shapes, positional relationship, etc. of components are not intended to limit the scope of the present invention exclusively thereto unless otherwise specified.

### Embodiment 1

(Electrolyte Membrane Composite)

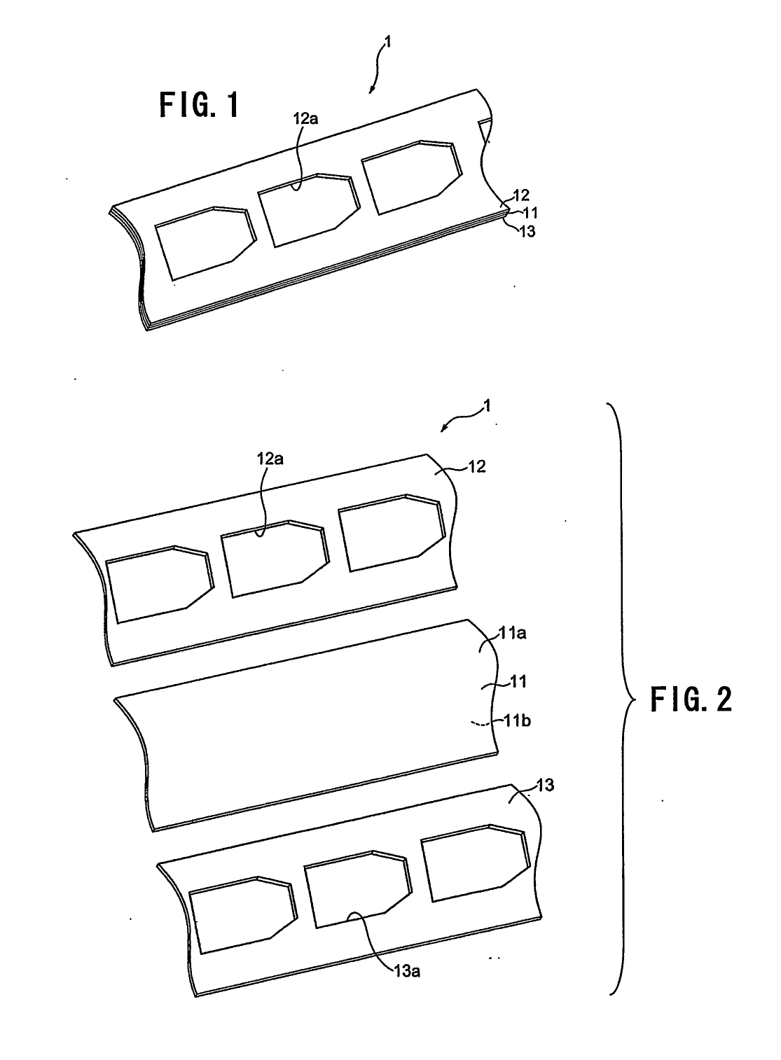

FIG. 1 is a perspective view of an electrolyte membrane composite 1 according to the present invention. FIG. 2 is an exploded view of the electrolyte membrane composite 1.

The electrolyte membrane composite 1 is composed of an electrolyte membrane 11, a masking member 12 attached to a first side 11a of the electrolyte membrane 11, and a masking member 13 attached to a second side 11b of the electrolyte membrane 11. The electrolyte membrane 11 has property of not allowing permeation of electrons but only allowing permeation of ions and thus is used for a proton-exchange membrane fuel cell. The electrolyte membrane 11 includes a proton-exchange electrolyte membrane, for example, an electrolyte membrane made of a perfluorosulfonate polymer, “NAFION” (registered trademark) available from DuPont Inc. (US), an electrolyte membrane made of aromatic hydrocarbon engineering plastics, an electrolyte membrane whose constituent material is a carbon material, fullerene (C₆₀), and an electrolyte membrane obtained by forming an electrolyte in a number of pores formed in a polyester film. The masking members 12 and 13 are paper or plastics, preferably, sheet-like members, film-like members, or webs made of a PVC-free material etc. Materials for the electrolyte membrane and masking members are exemplified above, but the present invention should not be construed as being limited to those materials.

The masking members 12 and 13 have plural holes 12a and 13a with a predetermined shape. The plural holes 12a and 13a are formed for forming a fuel electrode of a fuel cell. In short, the predetermined shape may conform to a fuel electrode shape. The thickness of the masking members 12 and 13 is set to be substantially the same as or larger than that of the fuel electrode. This is because, if the masking members 12 and 13 are thinner than the fuel electrode, the applied electrode ink overflows the hole, making it difficult to form the fuel electrode.

The masking members 12 and 13 are detachably attached to the electrolyte membrane 11. In light of preventing the electrolyte membrane 11 from being damaged and contaminated when the masking members 12 and 13 are peeled off from the electrolyte membrane 11, the masking members 12 and 13 are preferably attached to the electrolyte membrane 11 with slight adhesives approved by an electrolyte membrane supplier. Alternatively, the masking members 12 and 13 may be films applied with pressure-sensitive adhesives like cellophane tape, and the films may be attached to the electrolyte membrane 11. The masking members 12 and 13 may be autohesion films having property of self-adhering-to a target surface without any adhesive instead. The autohesion films may be attached to the electrolyte membrane 11. In general, holes with desired patterns may be bored in masking members in the form of being supplied from an electrolyte membrane supplier, for example, backing films or cover sheets laminated on both sides of “Nafion” (registered trademark) available from DuPont Inc. The backing films or cover sheets of “Nafion” are specified in DuPont Product Information “DuPont™ Nafion® PFSA Membranes NR-111 and NR-112” NAE 201 (November 2002).

(Storage Method)

The electrolyte membrane 11 absorbs moisture and swells when exposed to the air, and hence is desirably shielded from the air in storage.

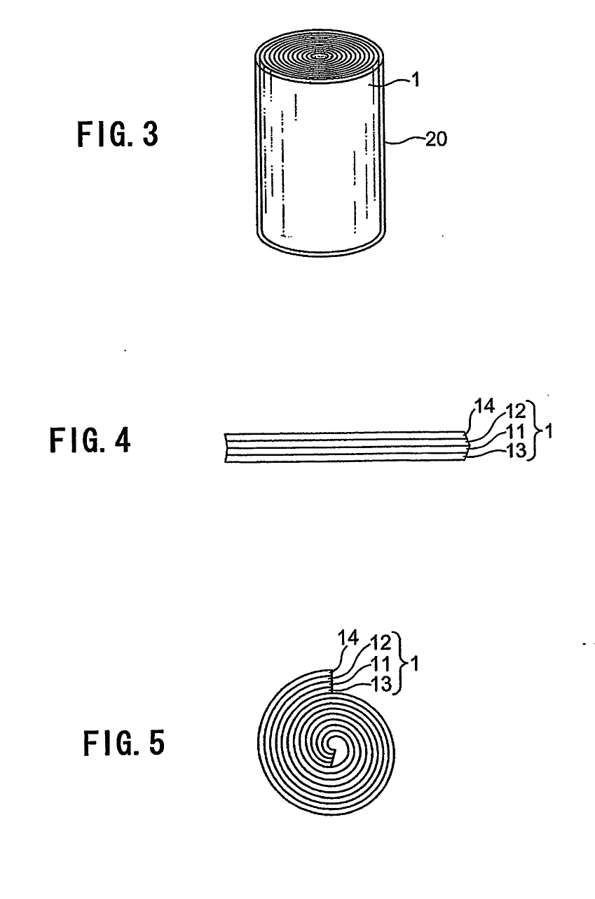

FIG. 3 shows how a wrapping material 20 wraps the rolled electrolyte membrane composite 1. Sealing a roll stock of the electrolyte membrane composite 1 with the wrapping material 20 makes it possible to shield the electrolyte membrane 11 from the air in storage. The wrapping material 20 is preferably a water vapor barrier film.

FIG. 4 shows the electrolyte membrane composite 1 whose one side is attached with a gas barrier sheet 14. The gas barrier sheet 14 is detachably attached onto the masking member 12 with a slight adhesive. Note that the gas barrier sheet 14 made of an autohesion material can be directly attached to the masking member 12 without any adhesive.

As shown in FIG. 5, the electrolyte membrane composite 1 is rolled with the gas barrier sheet 14 facing outwardly, so that the electrolyte membrane composite 1 is enclosed by the gas barrier sheet 14. Hence, the gas-shielded roll stock of the electrolyte membrane composite 1 can be obtained without wrapping the composite with any gas barrier material. If the roll stock is further wrapped with the-gas barrier wrapping material 20, its gas barrier performance can be improved.

The gas barrier sheets 14 may be attached to both sides of the electrolyte membrane composite 1, that is, respectively attached to the masking members 12 and 13.

(Method of Manufacturing Electrolyte Membrane-Electrode Assembly for Fuel Cell)

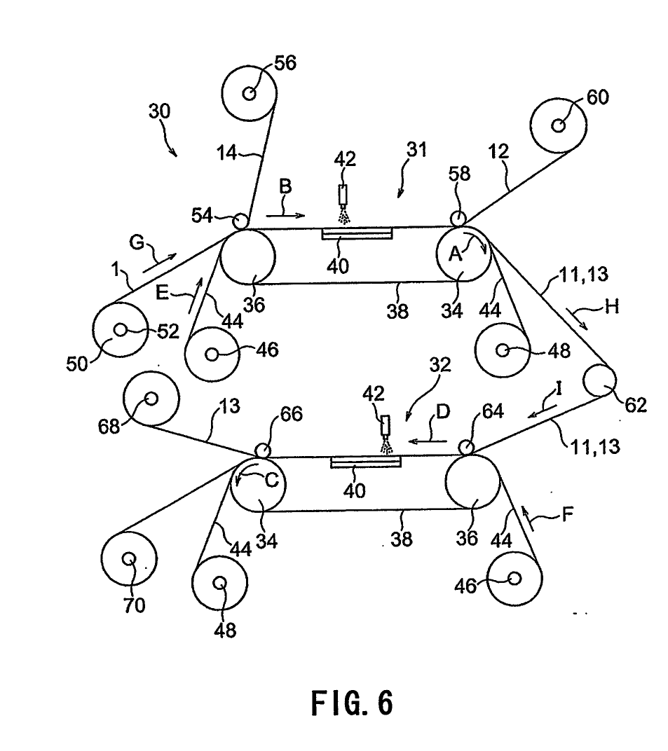

FIG. 6 is a schematic diagram of a coating device 30 for applying electrode ink to the electrolyte membrane composite 1.

A fuel cell (anode) is formed on one side of the electrolyte membrane 11 and an air electrode (cathode) is formed on the other side thereof.

The coating device 30 includes a first coating device 31 and a second coating device 32. The first coating device 31 is arranged above the second coating device 32. The first coating device 31 and the second coating device 32 have substantially the same structure. Hence, a description is only made of the first coating device 31, the same components are denoted by the same reference numerals, and a description of the second coating device 32 is omitted.

The first coating device 31 is composed of a driving roller 34, a driven roller 36, a screen belt (circulating member) 38 stretched over the driving roller 34 and the driven roller 36, a vacuum suction/heating device 40, and a nozzle 42 for applying electrode ink. The screen belt 38 rotates clockwise in a direction indicated by the arrow B in accordance with clockwise rotation of the driving roller 34 in a direction indicated by the arrow A.

In the second coating device 32, the screen belt 38 rotates counterclockwise in a direction indicated by the arrow D in accordance with counterclockwise rotation of the driving roller 34 in a direction indicated by the arrow C.

An underlying web 44 is put on the screen belt 38 and is made of an air-permeable material such as paper. The underlying web 44 is drawn from a take-up spindle 46 in a direction indicated by the arrow E, and then sucked to the screen belt 38 and transported in a direction indicated by the arrow B, and finally taken up by a take-up spindle 48. Similarly, in the second coating device 32, the underlying web 44 is drawn from the take-up spindle 46 in a direction indicated by the arrow F, and then sucked to the screen belt 38 and transported in a direction indicated by the arrow D, and finally taken up by the take-up spindle 48.

A roll stock 50 of the electrolyte membrane composite 1 is rotatably slid onto a take-up spindle 52 of the coating device 30. The electrolyte membrane composite 1 is drawn from the take-up spindle 52 in a direction indicated by the arrow G. The electrolyte membrane composite 1 is sucked onto the underlying web 44 and transported along with the movement of the screen belt 38 in a direction indicated by the arrow B.

When being attached to the electrolyte membrane composite 1, the gas barrier sheet 14 is taken up by a take-up spindle 56 through a guide roller 54. Thus, the gas barrier sheet 14 is peeled off from the electrolyte membrane composite 1. Note that in the first coating device 31, when being attached to the electrolyte membrane composite 1, the gas barrier sheet 14 can be also sucked to the screen belt 38 without using the underlying web 44 by rotating the roll stock 50 of the electrolyte membrane composite 1 in a reverse direction. More specifically, the gas barrier sheet 14 can substitute for the underlying web 44. As a result, it is possible to dispense with mechanisms of the take-up spindles 46, 48, and 56 and reduce costs for devices and members.

The electrolyte membrane composite 1 and the underlying web 44 are sucked to the screen belt 38 and heated by the vacuum suction/heating device 40. The electrode ink is applied from the nozzle 42 toward the holes 12a in the masking member 12 of the electrolyte membrane composite 1. The holes 12a are formed into a desired shape, making it possible to form on the first side 11a of the electrolyte membrane 11 a fuel electrode having a desired shape with ease. In the present invention, the masking members 12 and 13 are previously bonded to the electrolyte membrane composite 1, which eliminates the need to separately prepare a masking member, leading to a simple manufacturing process.

In the case of using a slot nozzle as the nozzle 42, the width of the underlying web 44 may be substantially equal to that of the electrolyte membrane composite 1. In the present invention, a type of the nozzle 42 or coater is not particularly limited. However, coating with a spray nozzle is more preferred than curtain coating as liquid film coating, roll coating or screen coating as contact liquid coating, or coating with a slot nozzle. The electrolyte membrane has a problem that the membrane is swelled with a solvent of electrode ink. To that end, it is important to volatilize as much solvent as possible before the electrode ink reaches the electrolyte membrane. For that purpose, the electrode ink is preferably applied from a spray nozzle in the form of fine particles that can contact with the air in a larger area. However, as for coating with the spray nozzle, a liquid is applied in a particle form, so that the particles are likely to spatter. When the spray nozzle is used as the nozzle 42, it is preferable to set the width of the underlying web 44 larger than that of the electrolyte membrane composite 1. The electrode ink ejected from the nozzle 42 may be slightly dispersed over the underlying web 44. However, the dispersed electrode ink adheres to the underlying web 44 and the underlying web 44 is taken up by the take-up spindle 48.

As discussed above, the dispersed electrode ink can be recovered or collected by using the underlying web 44. Hence, it is possible to provide a coating device adequate for environmental sanitation as well as to recover or collect expensive platinum contained in the electrode ink for reuse.

The masking member 12 attached to the upper side of the electrolyte membrane composite 1 is taken up by a take-up spindle 60 located in an upper portion through a guide roller 58. The masking member 12 is thereby peeled off from the electrolyte membrane composite 1. Note that the masking member 12 may keep moving to a downstream side instead of peeling off therefrom, and may be taken up in the final step.

The electrode ink applied to the electrolyte membrane 11 is fixed to the electrolyte membrane 11 through drying. The electrode ink may be dried through a vacuum chamber, or heated with hot air or with a heating roller, and thus fixed to the electrolyte membrane 11. Here, the ink may be fixed to the membrane in the final step.

The electrolyte membrane 11 and the masking member 13 are guided to the second coating device 32 by a guide roller 62 arranged in a lower portion. At this time, the transport direction of the electrolyte membrane 11 and the masking member 13 is reversed by the guide roller 62 from a direction indicated by the arrow H to a direction indicated by the arrow I. The masking member 13 is turned up in this way.

The electrolyte membrane 11 and the masking member 13 are guided by a guide roller 64, sucked onto the underlying web 44 of the second coating device 32, and transported in a direction indicated by the arrow D along with the movement of the screen belt 38. The first side 11a of the electrolyte membrane 11 where a fuel electrode is formed in the first coating device 31 is tuned down so as to contact with the underlying web 44, and the masking member 13 is turned up.

The electrolyte membrane 11, the masking member 13, and the underlying web 44 are sucked to the screen belt 38 and heated by the vacuum suction/heating device 40. The electrode ink is applied from the nozzle 42 toward the holes 13a of the masking member 13. The holes 13a are formed into a desired shape, making it possible to form on the second side 11b of the electrolyte membrane 11 a fuel electrode having a desired shape with ease.

The masking member 13 is taken up by a take-up spindle 68 located in an upper portion through a guide roller 66. Hence, the masking member 13 is peeled off from the electrolyte membrane 11.

The electrode ink applied to the electrolyte membrane 11 is fixed to the electrolyte membrane 11 through drying. The ink may be dried through a vacuum chamber, or heated with hot air or with a heating roller, and thus fixed to the electrolyte membrane 11.

The electrolyte membrane 11 is taken up by a take-up spindle 70. Alternatively, the electrolyte membrane 11 is transported to a cutting device (not shown) and cut into a desired size for use in an electrolyte membrane-electrode assembly for a fuel cell. In such a manner, the electrolyte membrane-electrode assembly for a fuel cell is completed, where the fuel electrode (anode) and the air electrode (cathode) are formed in the electrolyte membrane 11.

A fuel cell is manufactured using the thus-prepared electrolyte membrane-electrode assembly for a fuel cell (MEA).

### Embodiment 2

A description has been made of an example where the masking members are attached to both sides of the electrolyte membrane in Embodiment 1. In Embodiment 2 below, a description is directed to an example where a masking member is only attached to one side of an electrolyte membrane.

(Electrolyte Membrane Composite)

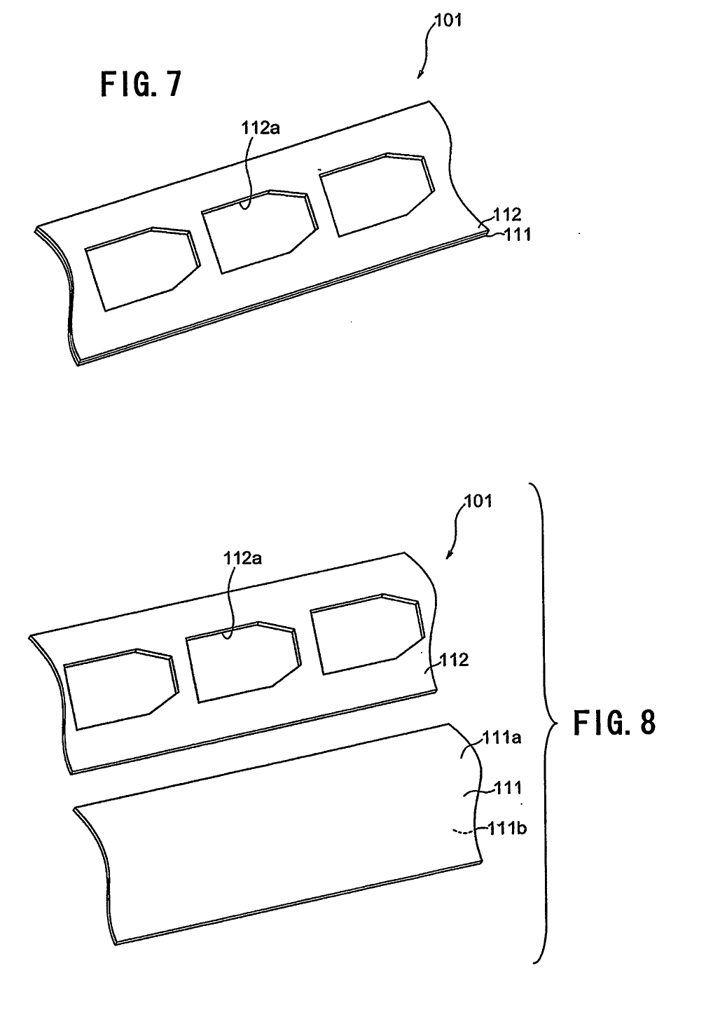

FIG. 7 is a perspective view of an electrolyte membrane composite 101 according to the present invention. FIG. 8 is an exploded view of the electrolyte membrane composite 101.

The electrolyte membrane composite 101 is composed of an electrolyte membrane 111 and a masking member 112 attached to a first side 111a of the electrolyte membrane 111. Plural holes 112a with a predetermined shape are bored in the masking member 112 for forming a fuel electrode of a fuel cell. The thickness of the masking member 112 is substantially the same as or larger than that of the fuel electrode.

The masking member 112 is detachably attached to the electrolyte membrane 111. In light of preventing the electrolyte membrane 111 from being damaged when the masking member 112 is peeled off from the electrolyte membrane 111, the masking member 112 is attached to the electrolyte membrane 111 with a slight adhesive. Alternatively, the masking member 112 is preferably an autohesion film having property of self-adhering to a target surface without any adhesive. The autohesion film may be attached to the, electrolyte membrane 111.

(Storage Method)

Similarly to Embodiment 1 as shown in FIG. 3, the electrolyte membrane composite 101 is rolled as a roll stock, the roll stock is wrapped with a gas barrier wrapping material, and the electrolyte membrane composite 101 is stored in the form of roll stock. The electrolyte membrane composite 101 is preferably rolled with the masking member 112 facing outwardly.

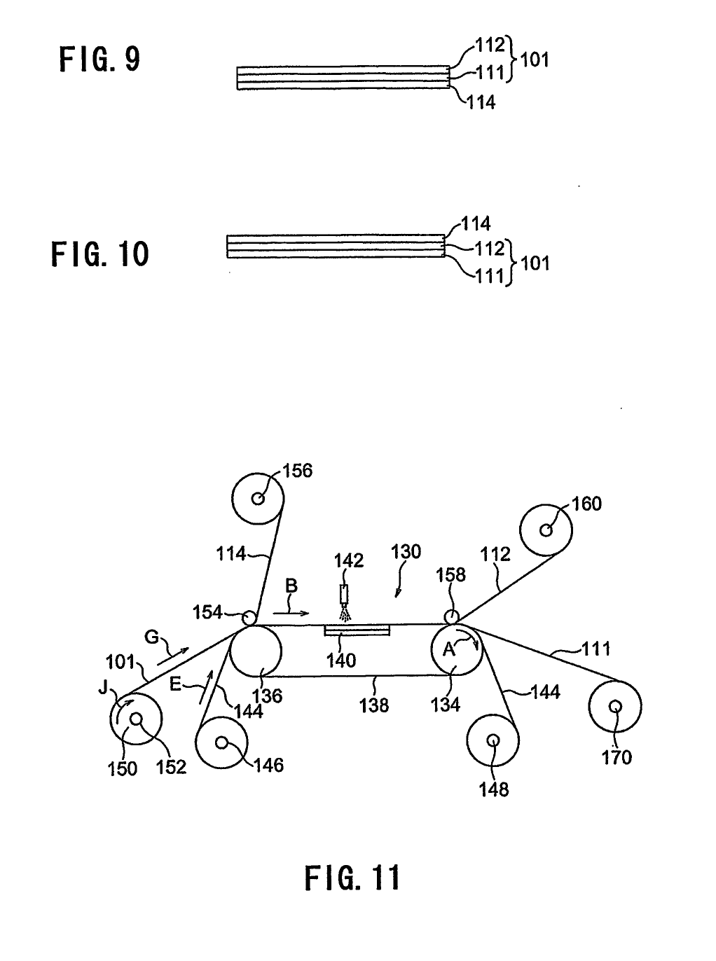

As another storage method, the gas barrier sheet 114 may be attached to one side of the electrolyte membrane composite 101. FIG. 9 shows the electrolyte membrane composite 101 where a second side 111b of the electrolyte membrane 111 is attached to the gas barrier sheet 114. The gas barrier sheet 114 is detachably attached to the electrolyte membrane 111 with a slight adhesive. Instead of using the slight adhesive, an adhesive may be used or a function of “Velcro” (registered trademark) may be imparted to the surface for bonding. Note that the gas barrier sheet 114 made of an autohesion material can be directly attached to the electrolyte membrane 111 without any adhesive. FIG. 10 shows the electrolyte membrane composite 101 having the masking member 112 attached to the gas barrier sheet 114.

The gas barrier sheets 114 may be attached to both sides of the electrolyte membrane composite 101, that is, respectively attached to the electrolyte membrane 111 and the masking member 112.

Similarly to Embodiment 1 as shown in FIG. 5, the electrolyte membrane composite 101 is rolled with the gas barrier sheet 114 facing outwardly and thus the gas barrier sheet 114 encloses the electrolyte membrane composite 101. As a result, the gas-shielded roll stock of the electrolyte membrane composite 101 can be obtained without wrapping the composite with any gas barrier material. If the roll stock is further wrapped with the gas barrier wrapping material, its gas barrier performance can be improved.

(Method of Manufacturing Electrolyte Membrane-Electrode Assembly for Fuel Cell)

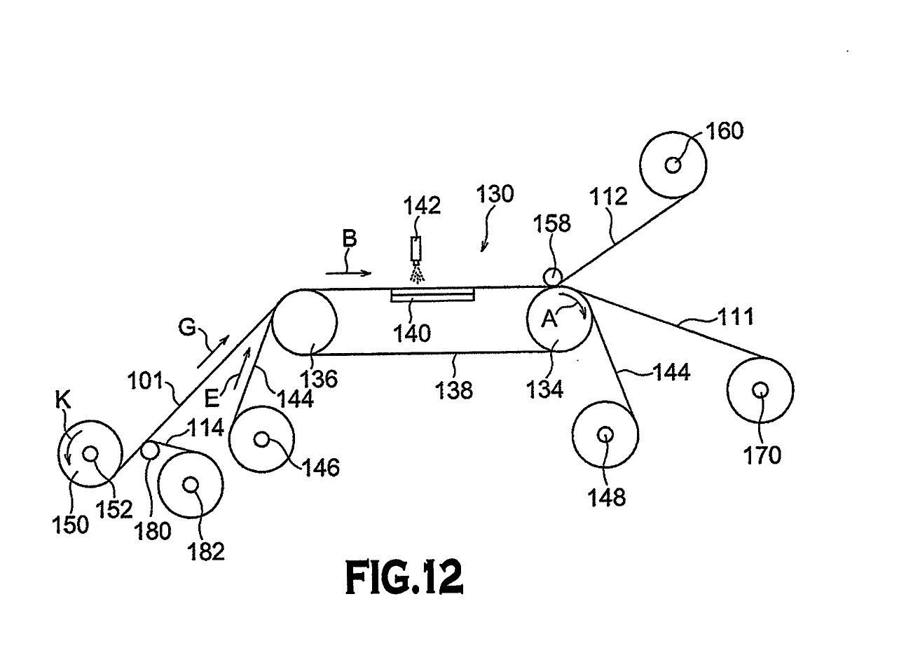

FIGS. 11 and 12 are schematic diagrams of a coating device 130 for applying electrode ink to the electrolyte membrane composite 101.

An electrode is formed on one side of the electrolyte membrane 111.

The coating device 130 is composed of a driving roller 134, a driven roller 136, a screen belt (circulating member) 138 stretched over the driving roller 134 and the driven roller 136, a vacuum suction/heating device 140, and a nozzle 142 for applying electrode ink. The screen belt 138 rotates clockwise in a direction indicated by the arrow B in accordance with clockwise rotation of the driving roller 134 (in a direction indicated by the arrow A.

An underlying web 144 is put on the screen belt 138 and is made of an air-permeable material such as paper. The underlying web 144 is drawn from a take-up spindle 146 in a direction indicated by the arrow E, and then sucked to the screen belt 138 and transported in a direction indicated by the arrow B, and finally taken up by a take-up spindle 148.

A roll stock 150 of the electrolyte membrane composite 101 is rotatably slid onto a take-up spindle 152 of the coating device 130. In the case where the gas barrier sheet 114 is not attached to the electrolyte membrane composite 101, as shown in FIG. 11, the roll stock 150 is slid onto the take-up spindle 152 such that the roll stock 150 of the electrolyte membrane composite 101 is rotated clockwise in a direction indicated by the arrow J and hence the electrolyte membrane composite 101 is drawn therefrom. The electrolyte membrane composite 101 is drawn from the take-up spindle 152 in a direction indicated by the arrow G. The electrolyte membrane composite 101 is sucked onto the underlying web 144 and transported along with the movement of the screen belt 138 in a direction indicated by the arrow B.

When the gas barrier sheet 114 is attached to the masking member 112 of the electrolyte membrane composite 101, as shown in FIG. 11, the roll stock 150 is slid onto the take-up spindle 152 such that the roll stock 150 of the electrolyte membrane composite 101 is rotated clockwise in a direction indicated by the arrow J and hence the electrolyte membrane composite 101 is drawn therefrom. This is because the electrolyte membrane composite 101 is rolled with the gas barrier sheet 114 constituting the outermost layer of the roll stock 150. To elaborate, the roll stock 150 is attached to the masking member 130 such that the electrolyte membrane 111, the masking member 112, and the gas barrier sheet 114 are laminated in this order. Then, the gas barrier sheet 114 is taken up by a take-up spindle 156 located in an upper portion through a guide roller 154. Thus, the gas barrier sheet 114 is peeled upwardly from the electrolyte membrane composite 101.

Meanwhile, when the gas barrier sheet 114 is attached to the electrolyte membrane 111 of the electrolyte membrane composite 101, as shown in FIG. 12, the roll stock 150 is slid onto the take-up spindle 152 such that the roll stock 150 of the electrolyte membrane composite 101 is rotated counterclockwise in a direction indicated by the arrow K and hence the electrolyte membrane composite. 101 is drawn therefrom. This is because the electrolyte membrane composite 101 is rolled with the gas barrier sheet 114 constituting the outermost layer of the roll stock 150. To elaborate, the roll stock 150 is attached to the masking member 130 such that the gas barrier sheet 114, the electrolyte membrane 111, and the masking member 112 are laminated in this order. Then, the gas barrier sheet 114 is taken up by a take-up spindle 182 located in a lower portion through a guide roller 180. Thus, the gas barrier sheet 114 is peeled downwardly from the electrolyte membrane composite 101.

The electrolyte membrane composite 101 and the underlying web 144 are sucked to the screen belt 138 and heated by the vacuum suction/heating device 140. The electrode ink is applied from the nozzle 142 to the electrolyte membrane 111 through the holes 112a in the masking member 112 of the electrolyte membrane composite 101. The holes 112a are formed into a desired shape, making it possible to form on the first side 111a of the electrolyte membrane 111 a fuel electrode having a desired shape with ease. In the present invention, the masking member 112 is previously bonded to the electrolyte membrane composite 101, which eliminates the need to separately prepare a masking member, leading to a simple manufacturing process. Also, the masking member 112 self-adheres to the electrolyte membrane 111 or is indirectly attached thereto with a slight adhesive. Thus, the masking member 112 never floats over the membrane. Therefore, it is possible to prevent such a situation where electrode ink infiltrates in between the masking member 112 and the electrolyte membrane 111, leading to a deformative electrode shape.

The masking member 112 is taken up by a take-up spindle 160 located in an upper portion through a guide roller 158. Hence, the masking member 112 is peeled off from the electrolyte membrane 111. Note that the masking member 112 may be peeled off in the final step.

The electrode ink applied to the electrolyte membrane 111 is fixed to the electrolyte membrane 111 through drying. The electrode ink may be dried through a vacuum chamber, or heated with hot air or with a heating roller, and thus fixed to the electrolyte membrane 111. Here, the ink may be fixed to the membrane in the final step.

The electrolyte membrane 111 is taken up by a take-up spindle 170. Alternatively, the electrolyte membrane 111 is transported to a cutting device (not shown) and cut into a desired size for use in an electrolyte membrane-electrode assembly for a fuel cell.

A fuel cell is manufactured using the thus-prepared electrolyte membrane-electrode assembly for a fuel cell (MEA).

### Embodiment 3

(Method of Manufacturing Electrolyte Membrane Composite)

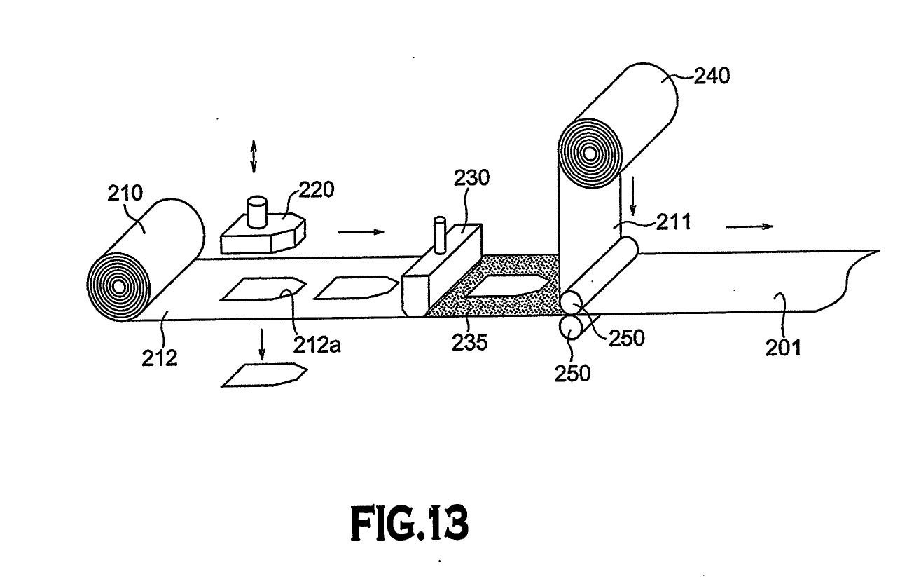

FIG. 13 illustrates a method of manufacturing an electrolyte membrane composite.

In FIG. 13, a masking member 212 is drawn from a masking member roll 210 while being punched with a punch 220 to form a hole 212a with a desired shape. The masking member 212 having the hole 212a bored therein is applied with a slight adhesive 235 from a slot nozzle 230 except for a portion corresponding to the hole 212a. An electrolyte membrane 211 is drawn from an electrolyte membrane roll 240 and attached to the masking member 212 by means of a pressure roll pair 250. An electrolyte membrane composite 201 is thus manufactured.

Note that the masking member 212 made of an autohesion material requires no step of applying an adhesive with the slot nozzle 230.

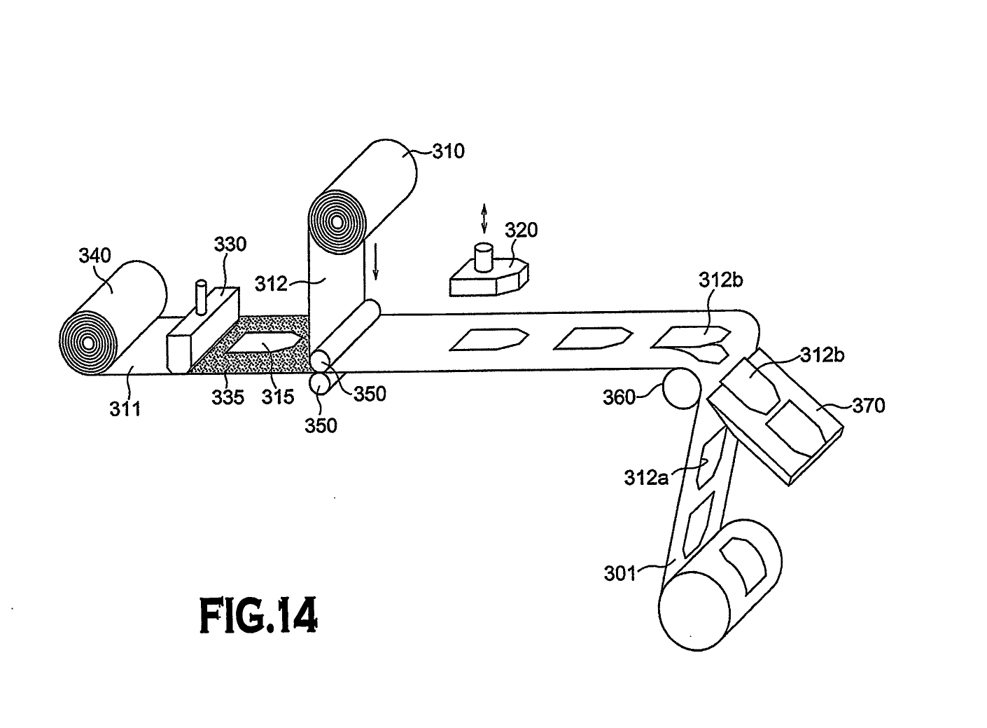

FIG. 14 illustrates another method of manufacturing an electrolyte membrane composite.

In FIG. 14, an electrolyte membrane 311 is drawn from an electrolyte membrane roll 340 while being applied with a slight adhesive 335 from a slot nozzle 330 except for a portion 315 corresponding to a desired shape. A masking member 312 is drawn from a masking member roll 310 and attached to the electrolyte membrane 311 by means of a pressure roll pair 350. The masking member 312 is punched into a desired shape by a punch 320 according to the portion not applied with the slight adhesive. At this point, the punch 320 is adjusted so as not to punch the electrolyte membrane 311. When the masking member 312 winds around a small-diameter roller 360 having a large curvature, a punch-through piece 312b peels therefrom by the self-stripping action, and is scooped up and scraped off by a scraper 370. An electrolyte membrane composite 301 is thus manufactured.

### Embodiment 4

(Method of Manufacturing Electrolyte Membrane-Electrode Assembly for Fuel Cell)

The electrolyte membrane-electrode assembly for a fuel cell is manufactured by applying the electrode ink to the electrolyte membrane in Embodiments 1 and 2. In Embodiment 4, an electrolyte membrane-electrode assembly for a fuel cell (MEA) is manufactured using a powder electrode material.

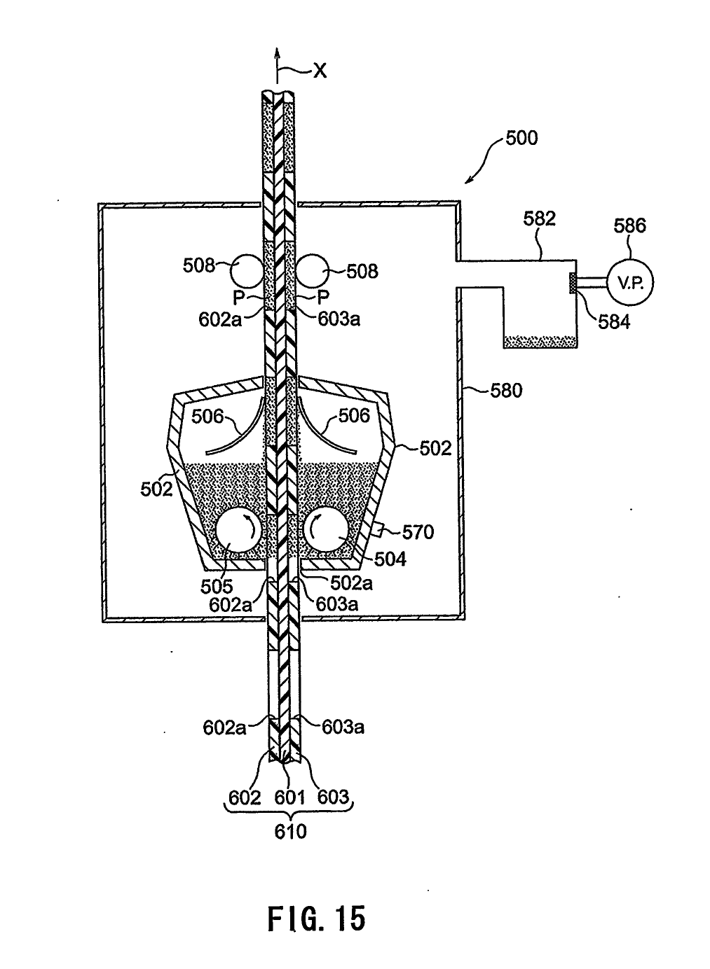

FIG. 15 is a schematic sectional view of a filling device for applying to, that is, filling in an electrolyte membrane composite a powder electrode material, which is aimed at manufacturing an electrolyte membrane-electrode assembly for a fuel cell (MEA).

A filling device 500 is composed of a container 502 containing a powder electrode material, and paired brush rollers 504 and 505 provided inside the container 502.

An electrolyte membrane composite 610 composed of an electrolyte membrane 601, and masking members 602 and 603 attached to both sides of the electrolyte membrane 601 is transported upwardly in a vertical direction as indicated by the arrow X through an opening 502a of the container 502. Holes 602a and 603a are bored in the masking members 602 and 603, respectively.

In course of transport of the electrolyte membrane 601 in the container 502, the brush rollers 504 and 505 apply to, that is, fill in the holes 602a and 603a of the masking members 602 and 603, respectively, a powder electrode material. Thus, an electrode with a desired shape can be formed on the electrolyte membrane 601.

Note that in this embodiment, the brush rollers 504 and 505 are used as applying (or filling) means, but the present invention may adopt any general rollers for pressing the material into the holes instead of using the brush rollers. Also, rubber or resin-made rollers are used and a powder electrode material may be attracted by means of an electrostatic force onto the electrolyte membrane 601 through the holes 602a and 603a of the masking members 602 and 603, respectively. There is no limitation on a coating or filling type or method; in place of filling the material, the material may be applied or filled by coating with a general powder coating spray gun, coating with a squeegee based on a rotary screen method, or imparting an electrostatic force thereto.

The filling device 500 may be provided with squeegees 506 downstream of the brush rollers 504 and 505 in a transport direction as indicated by the arrow X. The squeegees 506 function to remove the powder electrode material adhering to the surfaces of the masking members 602 and 603 or function as leveling members for leveling the powder electrode material filled in the holes 602a and 603a. The squeegees 506 thus provided can scrape off an excess of the electrode material. Note that the squeegees 506 are not limited to plate-like members as shown in FIG. 15 but may be roll- or brush-like members.

The filling device 500 may be provided with a pressure roller pair 508 downstream of the brush rollers 504 and 505 in the transport direction as indicated by the arrow X. The pressure roller pair 508 presses the electrolyte membrane composite 610 for increasing a bulk density of a powder electrode material P filled in the holes 602a and 603a. The powder electrode material P is an air-containing material, so that the powder electrode material filled in the holes 602a and 603a by the brush rollers 504 and 505 is low in bulk density. The bulk density is increased up to a predetermined density by pressing the powder electrode material P filled in the holes 602a and 603a by means of the pressure roller pair 508.

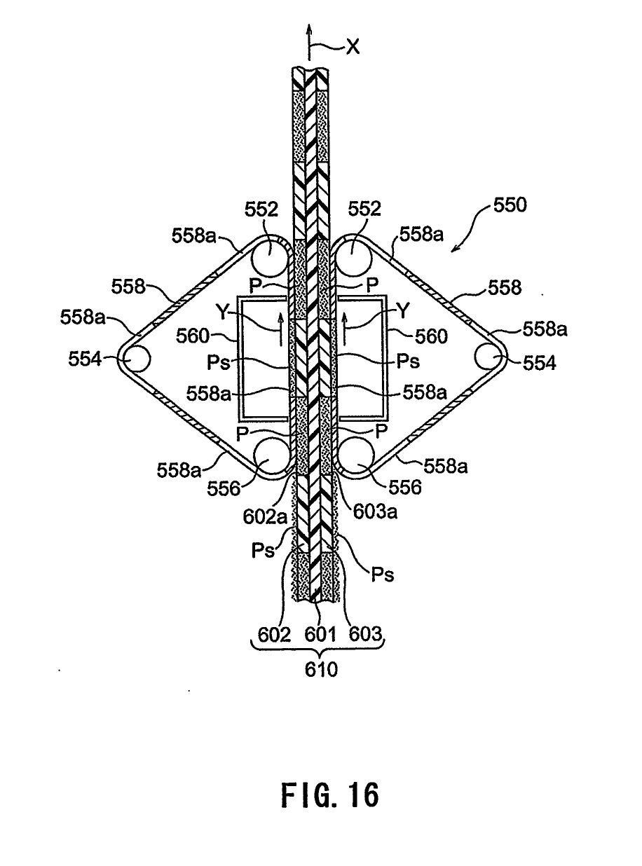

Here, a pressure/vacuum recovery system 550 as shown in FIG. 16 may be provided in place of the squeegees 506 and the pressure roller pair 508. The pressure/vacuum recovery system 550 is composed of a pressure/driving roller 552, a tension roller 554, a driven roller 556, and a belt 558 stretched over the pressure/driving roller 552, the tension roller 554, and the driven roller 556. The belt 558 is rotated in a direction indicated by the arrow Y by the pressure/driving roller 552.

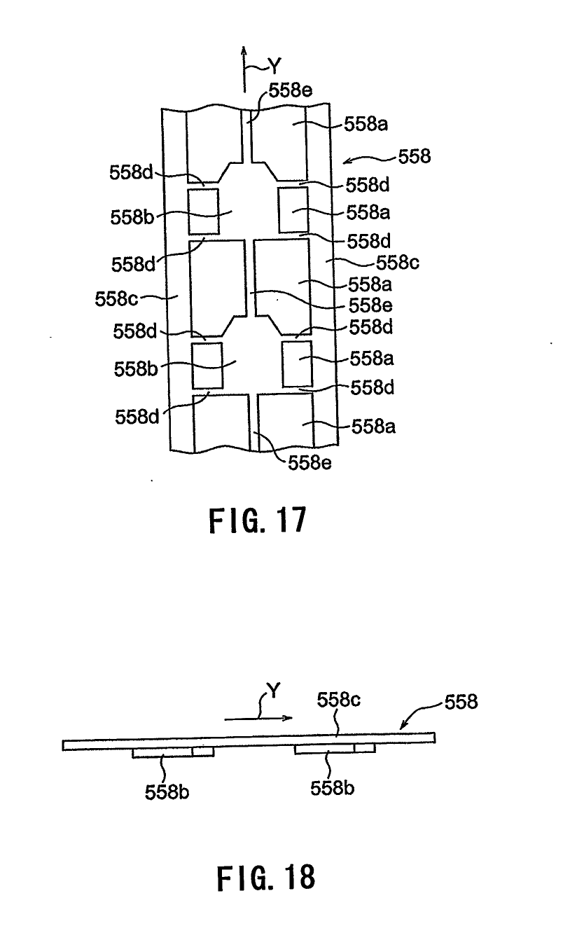

FIG. 17 is a plan view of the belt 558. FIG. 18 is a sectional view of the belt 558. The belt 558 has holes 558a complementary to the holes 602a and 603a having a desired shape and formed in the masking members 602 and 603, respectively. That is, the belt 558 has corresponding portions 558b that conform to the holes 602a and 603a, end portions 558c, first connection portions 558d for connecting the corresponding portions 558b and the end portions 558c, and second connection portions 558e for connecting between the adjacent corresponding portions 558b. The belt 558 is moved in a direction indicated by the arrow Y in synchronization with the transport of the electrolyte membrane composite 610 such that the corresponding portions 558b conform to the holes 602a and 603a of the masking members 602 and 603, respectively. While the corresponding portions 558b contact with the powder electrode material filled in the holes 602a and 603a, the end portions 558c, the first connection portions 558d, and the second connection portions 558e of the belt 558 are not in contact with the surfaces of the masking members 602 and 603 to secure a gap therebetween. Vacuum chambers 560 are each provided on an opposite side of the belt 558 facing each of the masking members 602 and 603. The vacuum chambers 560 are adapted to suck and recover an excess electrode material Ps adhering to the surfaces of the masking members 602 and 603 by means of vacuum force, to a recovery container (not shown). At this time, the powder electrode material P filled in the holes 602a and 603a of the masking members 602 and 603, respectively is covered with the corresponding portion 558b of the belt 558 and thus is by no means sucked by the vacuum force. The pressure/driving roller 552 presses the belt 558 against the electrolyte membrane composite 610, thereby pressing the powder electrode material P filled in the holes 602a and 603a to increase the bulk density of the powder electrode material P.

The filling device 500 may be provided with an oscillator 570 that is attached to the container 502 containing the powder electrode material. When the brush rollers 504 and 505 apply to, that is, fill in the holes 602a and 603a of the masking members 602 and 603, respectively, a powder electrode material, the oscillator 570 oscillates the container 502 to increase the bulk density of the powder electrode material filled in the holes 602a and 603a.

The filling device 500 is provided with a vacuum chamber 580 for applying to, that is, filling in the holes 602a and 603a of the masking members 602 and 603, respectively, a powder electrode material in a vacuum. The vacuum chamber 580 includes at least the brush rollers 504 and 505. The vacuum chamber 580 may further include the container 502, may furthermore include the squeegees 506, and in addition, may include the pressure roller pair 508. The vacuum chamber 580 is connected to a vacuum pump 586 through a recovery chamber 582 and a filter 584. The vacuum chamber 580 enables recovery of the powder electrode material dispersed to the periphery in the step of filling the powder electrode material.

There is no particular limitation on a degree of vacuum in the vacuum chamber. However, a vacuum chamber having the degree of vacuum of 1 to 40 kPa, which can be attained by a relatively low-cost vacuum pump is extremely effective for the electrode material and other such highly inflammable or combustible materials because such a chamber makes it possible to fill the powder electrode material with an improved bulk density as well as keep an oxygen concentration extremely low.

The filling step with the brush rollers 504 and 505 may be repeated in the filling device 500 as needed. Alternatively, the leveling step with the squeegees 506 and the filling step may be repeated. The pressing step with the pressure roller pair 508, the leveling step, and the filling step may be repeated instead.

After leaving the filling device 500, the electrolyte membrane composite 610 is transported to a fixing part (not shown) where a heating/pressure roller heats and presses the powder electrode material to fix the material to the electrolyte membrane 601. The fixing step is performed after the masking members 602 and 603 are peeled off. Alternatively, the fixing step may be performed before the masking members 602 and 603 are peeled off. In this way, the electrolyte membrane-electrode assembly for a fuel cell (MEA) is manufactured.

A fuel cell is manufactured using the thus-prepared electrolyte membrane-electrode assembly for a fuel cell (MEA).

Note that in Embodiment 4, the fixing part (not shown) is arranged outside the vacuum chamber 580, but may be arranged inside the vacuum chamber 580.

### Embodiment 5

(Method of Manufacturing Electrolyte Membrane-Electrode Assembly for Fuel Cell)

The electrolyte membrane-electrode assembly for a fuel cell (MEA) is manufactured by applying to, that is, filling in the electrolyte membrane composite laminated with the masking member a powder electrode material in Embodiment 4. In Embodiment 5, an electrolyte membrane-electrode assembly for a fuel cell (MEA) is manufactured by applying to, that is, filling in an electrolyte membrane laminated with no masking member a powder electrode material.

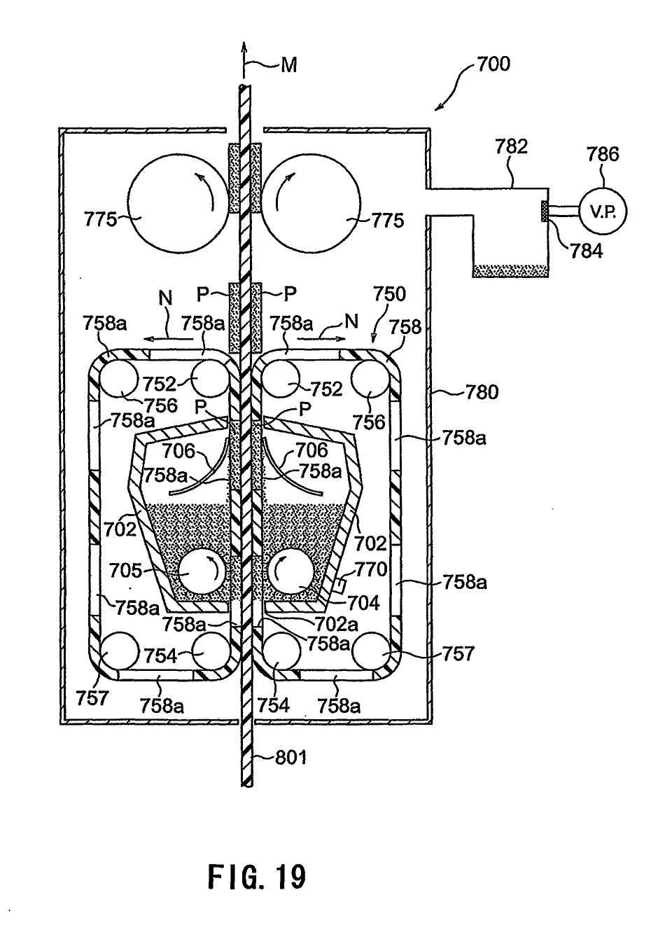

FIG. 19 is a schematic sectional view of a filling device for applying to, that is, filling in an electrolyte membrane a powder electrode material, which is aimed at manufacturing an electrolyte membrane-electrode assembly for a fuel cell (MEA).

A filling device 700 is composed of a container 702 containing a powder electrode material, paired brush rollers 704 and 705 provided in the container 702, and a masking device 750. The masking device 750 is composed of a pressure/driving roller 752, a tension roller 754, driven rollers 756 and 757, and a masking belt 758 stretched over the pressure/driving roller 752, the tension roller 754, and the driven rollers 756 and 757. The masking belt 758 is rotated in a direction indicated by the arrow N by the pressure/driving roller 752. Holes 758a are bored in the masking belt 758 for forming a fuel electrode (anode) and an air electrode (cathode).

An electrolyte membrane 801 is nipped between the two masking belts 758 and transported upwardly in the vertical direction as indicated by the arrow M through an opening 702a of the container 702. In course of transport of the electrolyte membrane 801 nipped between the two masking belts 758 in the container 702, the brush rollers 704 and 705 apply to, that is, fill in the holes 758a of the masking belt 758 a powder electrode material. Thus, an electrode having a desired shape can be formed on the electrolyte membrane 801.

Note that in this embodiment, the brush rollers 704 and 705 are used as applying (or filling) means, but the present invention may adopt any general rollers for pressing the material into the holes instead of using the brush rollers. Also, rubber or resin-made rollers are used, and a powder electrode material may be attracted onto the electrolyte membrane 801 through the holes 758a of the masking belt 758 by means of an electrostatic force.

There is no limitation on a coating or filling method or type; in place of filling the material, the material may be applied or filled by coating with a general powder coating spray gun, coating with a squeegee based on a rotary screen method, or imparting an electrostatic force thereto.

The filling device 700 may be provided with squeegees 706 downstream of the brush rollers 704 and 705 in a transport direction as indicated by the arrow M. The squeegees 706 function to remove the powder electrode material adhering to the surface of the masking belt 758 or function as leveling members for leveling the powder electrode material filled in the holes 758a. The squeegees 706 thus provided can scrape off an excess of the electrode material. Note that the squeegees 706 are not limited to plate-like members as shown in FIG. 19 but may be roll- or brush-like members.

The pressure/driving roller 752 presses the masking belt 758 against the electrolyte membrane 801, thereby pressing the powder electrode material P filled in the holes 758a to increase the bulk density of the powder electrode material P.

The filling device 700 may be provided with an oscillator 770 that is attached to the container 702 containing the powder electrode material. When the brush rollers 704 and 705 apply to, that is, fill in the holes 758a of the masking belt 758 a powder electrode material, the oscillator 770 oscillates the container 702 to increase the bulk density of the powder electrode material filled in the holes 758a.

The masking belt 758 separates from the electrolyte membrane 801 downstream of the pressure/driving roller 752. The powder electrode material P with a desired shape adheres onto the electrolyte membrane 801. The powder electrode material P is heated and pressed by a heating/pressure roller pair 775 to be fixed to the electrolyte membrane 801. In this way, the electrolyte membrane-electrode assembly for a fuel cell (MEA) is manufactured.

A fuel cell is manufactured using the thus-prepared electrolyte membrane-electrode assembly for a fuel cell (MEA).

The filling device 700 is provided with a vacuum chamber 780 for applying to, that is, filling in the holes 758a of the masking belt 758 a powder electrode material in a vacuum. The vacuum chamber 780 includes the brush rollers 704 and 705, the container 702, the squeegees 706, the masking device 750, and the heating/pressure roller pair 775. The heating/pressure roller pair 775 may be arranged outside the vacuum chamber 780. The vacuum chamber 780 is connected to a vacuum pump 786 through a recovery chamber 782 and a filter 784. The vacuum chamber 780 enables recovery of the powder electrode material dispersed to the periphery in the step of filling the powder electrode material.

The filling step with the brush rollers 704 and 705 may be repeated in the filling device 700 as needed. Alternatively, the leveling step with the squeegees 706 and the filling step may be repeated. Also, a pressure roller (not shown) may be additionally provided downstream of the squeegees 706. The pressing step with the pressure roller, the leveling step, and the filling step may be repeated.

### Embodiment 6

(Method of Manufacturing Electrolyte Membrane-Electrode Assembly for Fuel Cell)

In Embodiment 6, an electrolyte membrane-electrode assembly for a fuel cell (MEA) is manufactured by applying to, that is, filling in an electrolyte membrane laminated with no masking member a powder electrode material.

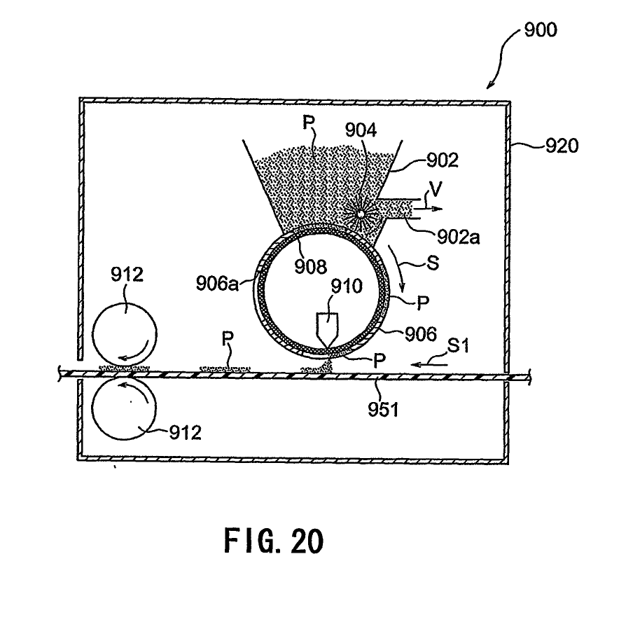

FIG. 20 is a schematic sectional view of a coating device for applying a powder electrode material to an electrolyte membrane, which is aimed at manufacturing an electrolyte membrane-electrode assembly for a fuel cell (MEA).

A coating device 900 may be desirably a coating device as shown in FIG. 3 of Japanese Patent Application Laid-open No. 5-76819.

The coating device 900 includes: a hopper 902 containing a powder electrode material; a rotary brush 904 arranged in the hopper 902; a hollow roll 906 having a hole 906a bored into a desired electrode shape; a screen 908 provided on the inner periphery of the hollow roll 906; and a compressed gas slit nozzle 910 provided inside the screen 908. The screen 908 has fine meshes as compared with a particle size of the powder electrode material. The outer diameter of the screen 908 is substantially equal to the inner diameter of the hollow roll 906. The screen 908 is attached to the hollow roll 906 and rotated together with the roll in a direction indicated by the arrow S.

The powder electrode material P in the hopper 902 is filled in the hole 906a bored in the hollow roll 906 by the rotary brush 904. The powder electrode material P is stably filled therein by sucking the material from a suction port 902a of the hopper 902 (as denoted by V). The powder electrode material sucked from the suction port 902a may be recharged in the hopper 902 for circulation.

The hollow roll 906 having the powder electrode material P filled in the hole 906a rotates in the direction indicated by the arrow S. An electrolyte membrane 951 is transported in a direction indicated by the arrow S1. The hollow roll 906 is arranged facing the transported electrolyte membrane 951. The compressed gas slit nozzle 910 is disposed so as to face the electrolyte membrane 951 across the hollow roll 906. When reaching the compressed gas slit nozzle 910, the powder electrode material P filled in the hole 906a is applied to the electrolyte membrane 951 by a compressed gas ejected from the compressed gas slit nozzle 910. The hole 906a has a desired electrode shape, so that the powder electrode material P is applied to the electrolyte membrane 951 with the desired electrode shape. The electrolyte membrane 951 is transported in the direction indicated by the arrow S1, nipped by a heating/pressure roller pair 912 disposed on a downstream side, and heated and pressed, whereby the powder electrode material P is fixed to the electrolyte membrane 951. In this way, an electrolyte membrane-electrode assembly for a fuel cell (MEA) is manufactured.

A fuel cell is manufactured using the thus-prepared electrolyte membrane-electrode assembly for a fuel cell (MEA).

Note that the coating device 900 may be provided with a low-pressure chamber 920. If the low-pressure chamber 920 is equipped with a recovery system and a coating operation is carried out in the low-pressure chamber 920, the powder electrode material dispersed to the periphery can be recovered.

### Embodiment 7

(Method of Manufacturing Electrolyte Membrane-Electrode Assembly for Fuel Cell)

In Embodiment 7, applying, that is, filling electrode ink and applying, that is, filling a powder electrode material are combined with each other.

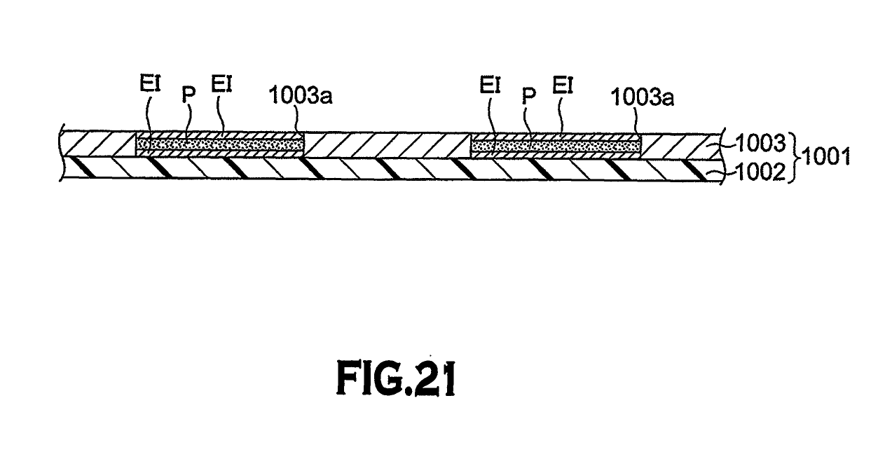

FIG. 21 shows an example of a case of applying an electrode ink EI and the powder electrode material P one on top of the other. An electrolyte membrane composite 1001 includes an electrolyte membrane 1002 and a masking member 1003 laminated on the electrolyte membrane 1002. The masking member 1003 has a hole 1003a bored into a desired electrode shape.

The above-mentioned filling device fills in the hole 1003a the electrode ink EI, the powder electrode material P, and the electrode ink EI in this order, making it possible to readily produce an electrode including a laminate composed of the electrode ink EI and the powder electrode material P.

Note that there is no particular limitation on types of the electrode ink and powder electrode material, the order of laminating those, and means for laminating those. A method of mixing and applying the electrode ink and the powder electrode material is also included in the present invention.

Note that in the present invention, description is focused on the electrolyte membrane. However, the present invention is applicable to a method of laminating a gas diffusion layer (GDL), PTFE used as an indirect transfer film, PET or PP treated into an easily detachable form, or other such masking member having a hole on one side, and applying the electrode ink etc. That is, the electrolyte membrane of the present invention, which is substituted by a gas diffusion layer or indirect transfer film, is within the scope of the present invention.

As set forth above, according to the present invention, it is possible to provide the electrolyte membrane, the electrolyte membrane composite, the method of manufacturing an electrolyte membrane composite, the electrolyte membrane-electrode assembly for a fuel cell, and the method of manufacturing an electrolyte membrane-electrode assembly for a fuel cell, for manufacturing the electrode having a desired pattern with high quality and highly efficient productivity.

According to the present invention, the electrode having a desired shape can be formed with accuracy without leaving a gap between the electrolyte membrane and the masking member.

Also, it is unnecessary to separately mount the masking member to the coating device. The electrode with the desired shape (pattern) can be manufactured with accuracy only by mounting the electrolyte membrane of the present invention to the coating device.

In addition, according to the present invention, the electrode ink or/and powder electrode material adhering to the masking member and dried are taken up together with the masking member. Hence, the taken up masking member is transported to a catalyst manufacturer for reuse of platinum. Consequently, it is possible to dispense with a washing solvent for cleaning the masking member and to skip the cleaning step.

The present invention is not limited to the above-mentioned embodiments but can be embodied in a variety of other modes without departing from a characteristic matter of the present invention. Hence, the above-mentioned embodiments are merely given as an example and should not be exclusively construed. The scope of the present invention is not restricted to this specification at all but is only defined by the scope of claims. Further, all modifications and changes within the scope of claims and its equivalent fall within the scope of the present invention.

1. An electrolyte membrane for a fuel cell before an electrode is applied to said electrolyte membrane, a masking member having a hole bored in a shape of a desired electrode being laminated on at least one side of said electrolyte membrane.

2. An electrolyte membrane for a fuel cell according to claim 1, wherein masking members having similar holes bored in a shape of a desired electrode are laminated on both sides of said electrolyte membrane.

3. An electrolyte membrane for a fuel cell according to claim 1, wherein said masking member self-adheres to said electrolyte membrane or adheres to said electrolyte membrane through a slight adhesive.

4. An electrolyte membrane for a fuel cell according to claim 1, wherein said electrolyte membrane and/or said masking member is a web, and said electrolyte membrane is made into a roll stock.

5. An electrolyte membrane for a fuel cell according to claim 1, wherein said electrolyte membrane is cut into sheets.

6. An electrolyte membrane for a fuel cell according to claim 1, wherein a gas barrier sheet or web is laminated on at least one masking member.

7. An electrolyte membrane for a fuel cell according to claim 1, wherein a thickness of said masking member is substantially the same as or larger than a thickness of an electrode to be formed in a post-process.

8. An electrolyte membrane for a fuel cell according to claim 1, wherein said electrolyte member is wrapped with a gas barrier wrapping material.

9. An electrolyte membrane-electrode assembly for a fuel cell, wherein said electrolyte membrane-electrode assembly is manufactured by applying or filling in an electrode ink or/and a powder electrode material on an electrolyte membrane for a fuel cell through a hole of a masking member of the electrolyte membrane for the fuel cell as recited in claim 1, and by peeling off the masking member.

10. An electrolyte membrane-electrode assembly for a fuel cell according to claim 9, wherein the electrode ink or/and the powder electrode material applied or filling in on the electrolyte membrane for the fuel cell is fixed to the electrolyte membrane for the fuel cell.

11. An electrolyte membrane-electrode assembly for a fuel cell according to claim 10, wherein the electrode ink or/and the powder electrode material is dried or heated or/and pressed so as to be fixed to the electrolyte membrane for the fuel cell.

12. A fuel cell, wherein said fuel cell uses an electrolyte membrane-electrode assembly as recited in claim 9.

13. An electrolyte membrane composite, comprising:
an electrolyte membrane; and
a masking member provided with a plurality of holes, wherein said masking member is detachably attached to one side of said electrolyte membrane.

14. An electrolyte membrane composite according to claim 13, wherein said holes are shaped in a shape of a fuel electrode for a fuel cell.

15. An electrolyte membrane composite according to claim 13, further comprising a masking member detachably attached to the other side of said electrolyte membrane.

16. An electrolyte membrane composite according to claim 13, further comprising a gas barrier sheet.

17. An electrolyte membrane composite according to claim 16, wherein said gas barrier sheet is detachably attached to said masking member.

18. An electrolyte membrane composite according to claim 16, wherein said gas barrier sheet is detachably attached to said electrolyte membrane.

19. An electrolyte membrane composite according to claim 13, wherein said masking member is made of an autohesion material.

20. An electrolyte membrane composite according to claim 16, wherein said gas barrier sheet is made of an autohesion material.

21. An electrolyte membrane composite according to claim 13, wherein said electrolyte membrane composite is wound to be made into a roll stock.

22. An electrolyte membrane composite according to claim 13, wherein said electrolyte membrane composite is cut to be made into sheets each of which has at least one hole.

23. An electrolyte membrane composite according to claim 13, wherein said electrolyte membrane composite is wrapped with a gas barrier wrapping material.

24. A method of manufacturing an electrolyte membrane composite having an electrolyte membrane and a masking member, said method comprising:
boring a desired shape hole in the masking member; and
thereafter, attaching the masking member to the electrolyte membrane.

25. A method of manufacturing an electrolyte membrane composite having an electrolyte membrane and a masking member, said method comprising:
attaching the masking member to the electrolyte membrane; and
thereafter, boring a desired shape hole in the masking member.

26. A method of manufacturing an electrolyte membrane-electrode assembly for a fuel cell, comprising:
installing rotatably a roll stock of an electrolyte membrane composite having an electrolyte membrane and a masking member provided with a plurality of holes;
drawing the electrolyte membrane composite from the roll stock;
applying or filling in an electrode ink or/and a powder electrode material on the electrolyte membrane through the plurality of holes of the masking member while transporting the electrolyte membrane composite; and
peeling off the masking member from the electrolyte membrane.

27. A method of manufacturing an electrolyte membrane-electrode assembly for a fuel cell, comprising:
installing rotatably a roll stock of an electrolyte membrane composite having an electrolyte membrane, a masking member provided with a plurality of holes, and a gas barrier sheet;
drawing the electrolyte membrane composite from the roll stock;
peeling off the gas barrier sheet;
applying or filling in an electrode ink or/and a powder electrode material on the electrolyte membrane through the plurality of holes of the masking member while transporting the electrolyte membrane composite; and
peeling off the masking member from the electrolyte membrane.

28. A method of manufacturing an electrolyte membrane-electrode assembly for a fuel cell, comprising:
installing rotatably a roll stock of an electrolyte membrane composite having an electrolyte membrane, a first masking member attached to a first side of the electrolyte membrane and provided with a plurality of holes, and a second masking member attached to a second side of the electrolyte membrane and provided with a plurality of holes;
drawing the electrolyte membrane composite from the roll stock;
applying or filling in an electrode ink or/and a powder electrode material on the first side of the electrolyte membrane through the plurality of holes of the first masking member while transporting the electrolyte membrane composite;
peeling off the first masking member from the electrolyte membrane;
reversing the electrolyte membrane and the second masking member;
applying or filling in the electrode ink or/and the powder electrode material on the second side of the electrolyte membrane through the plurality of holes of the second masking member while transporting the electrolyte membrane and the second masking member; and
peeling off the second masking member from the electrolyte membrane.

29. A method of manufacturing an electrolyte membrane-electrode assembly for a fuel cell, comprising:
installing a sheet of an electrolyte membrane composite having an electrolyte membrane and a masking member provided with at least one hole;
applying or filling in an electrode ink or/and a powder electrode material on the electrolyte membrane through the at least one hole of the masking member; and
peeling off the masking member from the electrolyte membrane.

30. A method according to claim 26, further comprising fixing the electrode ink or/and the powder electrode material to the electrolyte membrane.

31. A method of manufacturing an- electrolyte membrane-electrode assembly for a fuel cell, comprising:
transporting an electrolyte membrane composite having an electrolyte membrane, a first masking member attached to a first side of the electrolyte membrane and provided with a plurality of holes, and a second masking member attached to a second side of the electrolyte membrane and provided with a plurality of holes; and
filling in or/and applying a powder electrode material on the electrolyte membrane through the plurality of holes of the first and second masking members while transporting the electrolyte membrane.

32. A method according to claim 31, further comprising increasing a density of the powder electrode material filled in or applied to the plurality of holes of the first and second masking members.

33. A method according to claim 32, further comprising reiterating said filling in or/and applying and said increasing the density of the powder electrode material.

34. A method according to any one of claim 31, further comprising:
heating or/and pressing the powder electrode material; and
peeling off the first and second masking members.

35. A method according to claim 31, wherein at least said filling in or/and applying the powder electrode material is performed in vacuum.

36. A method according to any one of claim 31, further comprising cutting the electrolyte membrane.

37. An electrolyte membrane-electrode assembly for a fuel cell, wherein said electrolyte membrane-electrode assembly is manufactured by using a method as recited in claim 26.

38. A fuel cell, wherein said fuel cell uses an electrolyte membrane-electrode assembly as recited in claim 37.

39. A method of manufacturing an electrolyte membrane-electrode assembly for a fuel cell, comprising:
laminating a masking member provided with a hole bored in a shape of an electrode onto a gas diffusion layer or/and an indirect transfer film for an electrode;
applying or filling in an electrode ink or/and a powder electrode material on the gas diffusion layer or/and the indirect transfer film through the hole;
peeling the masking member; and
transferring or heat-pressing the electrode ink or/and the powder electrode onto an electrolyte membrane.

40. A method according to claim 39, further comprising:
forming an anode and a cathode on the gas diffusion layer or/and the indirect transfer film for both electrodes; and
at the same time transferring or pressing the anode and the cathode onto the electrolyte membrane.

41. An electrolyte membrane-electrode assembly for a fuel cell, wherein said electrolyte membrane-electrode assembly is manufactured by using a method as recited in claim 39.
